(19) United States
(12) Patent Application Publication
(10) Pub. No.: US 2008/0282549 A1
(43) Pub. Date: Nov. 20, 2008

(54) GARDENING SHEAR

(76) Inventor: Thomas LIN, Taichung County (TW)

Correspondence Address: BROWDY AND NEIMARK, P.L.L.C.;624 NINTH STREET, NW, SUITE 300, WASHINGTON, DC, 20001-5303, US

(21) Appl. No.: 11/854,251

(22) Filed: Sep. 12, 2007

(30) Foreign Application Priority Data
May 16, 2007 (TW) 96207922

(51) Int. Cl. B26B 13/00

(52) U.S. Cl. 30/194

(57) ABSTRACT

A gardening shear includes two handles, a stationary cutting blade mounted on one handle and having a first sliding groove and a first retaining block, a movable cutting blade having a second sliding groove for insertion of the first retaining block of the stationary cutting blade and a second retaining block inserted into the first sliding groove of the stationary cutting blade such that the movable cutting blade is movable relative to the stationary cutting blade along longitudinal axes of the first sliding groove and the second sliding groove, a chain having two ends respectively fixed to the movable cutting blade, and a driving bar having a bottom mounted on the other handle and a top pivotally mounted on the stationary cutting blade and provided with a teeth portion engaged with the chain for driving the movable cutting blade to move relative to the stationary cutting blade.

### BACKGROUND OF THE INVENTION

1. Field of the Invention

The present invention relates generally to a gardening implement, and more specifically to a gardening shear that can efficiently cut branches.

2. Description of the Related Art

A conventional gardening shear mainly comprises two handles and a pair of scissors fixed to the handles and pivotally mounted to each other. When the gardening shear is in use, a user holds the handles to force cutting edges of the scissors to move toward each other for clipping branches.

At the outset of trimming a branch, the branch, which is placed in the cutting mouth for cutting, is often caused to slip toward the tip ends of the cutting edges of the scissors due to the cutting action of scissor-like movement. As a result, the user may have to manually move back the branch to be cut from the tip ends to the root ends of the cutting edges of the scissors for saving cutting effort. In addition, if the user is trimming a stout branch, the manual action of moving back the slipped branch may have to be repeated several times until the stout branch is cut away. Therefore, the conventional gardening shear is inefficient in use.

### SUMMARY OF THE INVENTION

The present invention has been accomplished in view of the above-noted circumstances. It is one objective of the present invention to provide a gardening shear, which is efficient in use.

It is another objective of the present invention to provide a gardening shear, which has simple structure for reducing manufacturing cost.

To achieve these objectives of the present invention, the gardening shear comprises two handles, a stationary cutting blade, a movable cutting blade, a chain and a driving bar. The stationary cutting blade is mounted on one handle and provided with a first sliding groove and a first retaining block. The movable cutting blade has a second sliding groove for insertion of the first retaining block of the stationary cutting blade and a second retaining block inserted into the first sliding groove of the stationary cutting blade such that the movable cutting blade is movable relative to the stationary cutting blade along longitudinal axes of the first sliding groove and the second sliding groove. The chain has two ends respectively fixed to the movable cutting blade. The driving bar has a bottom mounted on the other handle and a top pivotally mounted on the stationary cutting blade and provided with a teeth portion engaged with the chain for driving the movable cutting blade to move relative to the stationary cutting blade. As a result, the present invention can provide a cutting action of linear movement rather than a cutting action of scissor-like movement of the prior art gardening shear, thereby preventing the object to be cut from slip of the cutting mouth of the gardening shear.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a front view of a gardening shear according to a preferred embodiment of the present invention; and

FIG. 2 is a schematic drawing showing the gardening shear of the preferred embodiment of the present invention at work.

### DETAILED DESCRIPTION OF THE INVENTION

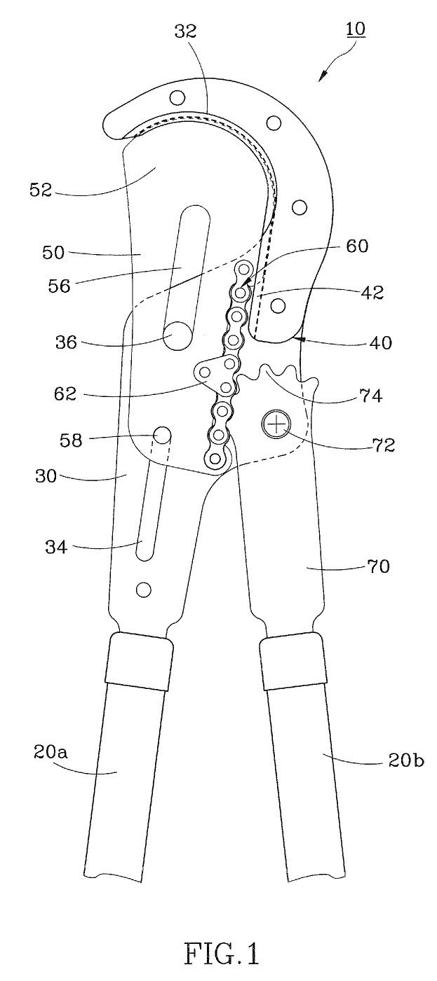

Referring to FIG. 1, a gardening shear 10 in accordance with a preferred embodiment of the present invention comprises two handles 20a and 20b, a stationary cutting blade 30, an anvil block 40, a movable cutting blade 50, a chain 60 and a driving bar 70.

The stationary cutting blade 30 has a bottom firmly inserted in a top of the handle 20a. The stationary cutting blade 30 is provided at a top thereof with a curved first cutting edge 32 and provided at a middle part thereof with a first sliding groove 34 and a first retaining block 36 located above the first sliding groove 34.

The anvil block 40 is configured to be fixed to the first cutting edge 32 of the stationary cutting blade 30 and has a guiding slot 42.

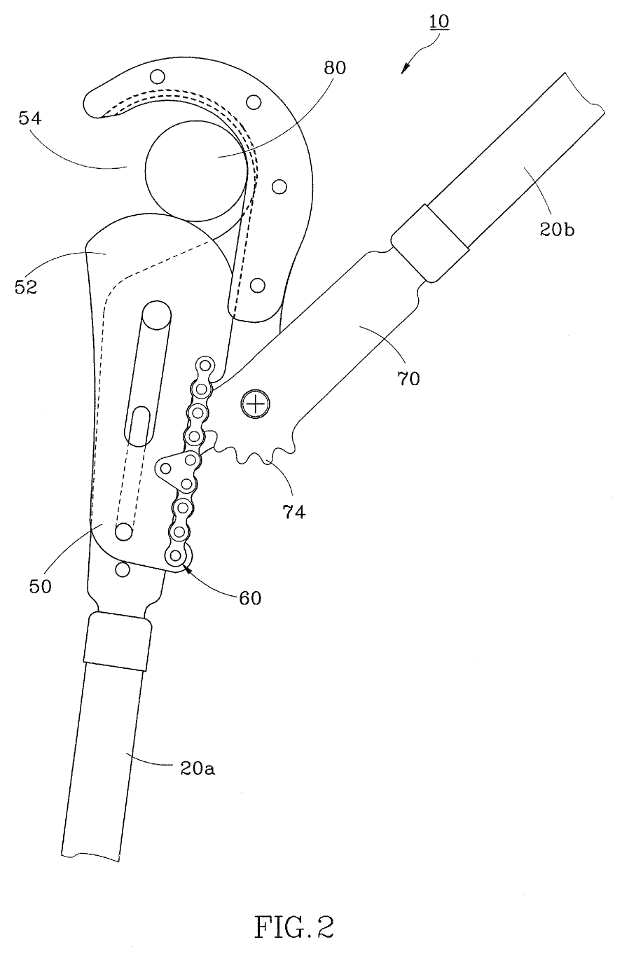

The movable cutting blade 50 is provided at a top thereof with an arc-shaped second cutting edge 52 having a part thereof inserted in the guiding slot 42 of the anvil block 40 such that a cutting mouth 54 is formed between the first cutting edge 32 of the stationary cutting blade 30 and the second cutting edge 52 of the movable cutting blade 50 for accommodation of an object, for example a branch 80 as shown in FIG. 2, to be cut. The movable cutting blade 50 has a second sliding groove 56, which is the same in length as the first sliding groove 34 of the stationary cutting blade 30, for insertion of the first retaining block 36 of the stationary cutting blade 30, and a second retaining block 58, which is located under the second sliding groove 56 and inserted in the first sliding groove 34 of the stationary cutting blade 30, such that the second cutting edge 52 of the movable cutting blade 50 can linearly move relative to the first cutting edge 32 of the stationary cutting edge 30 along the guiding slot 42 of the anvil block 40 and longitudinal axes of the first sliding groove 34 of the stationary cutting edge 30 and the second sliding groove 56 of the movable cutting blade 50 for cutting.

The chain 60 has two ends respectively fastened to one side of the movable cutting blade 50, and a reinforcement member 62 connected with the movable cutting blade 50 for strengthening structural strength.

The driving bar 70 has a bottom firmly inserted in a top of the handle 20b and is pivotally mounted on the stationary cutting blade 30 by a pivot 72 at a top thereof. In addition, the driving bar 70 is provided at the top thereof with a teeth portion 74 engaged with the chain 60 such that the movable cutting blade 50 can be driven by the driving bar 70 to move relative to the stationary cutting blade 30.

When a user wants to use the gardening shear 10 to cut a branch 80, the user can hold the handles 20a and 20b by hands and force the handle 20b to move upward so as to drive the second cutting edge 52 of the movable cutting blade 50 to move away from the first cutting edge 32 of the stationary cutting blade 30 through the engagement of the teeth portion 74 of the driving bar 70 and the chain 60, as shown in FIG. 2, and then let the to-be-cut branch 80 be placed in the cutting mouth 54. Thereafter, the user can force the handle 20b to move downward such that the second cutting edge 52 of the movable cutting blade 50 is moved toward the first cutting edge 32 of the stationary cutting blade 30 to cut the branch 80 placed in the mouth 54.

By means of the aforesaid design, as the cutting action is executed, the first cutting edge 32 of the stationary cutting blade 30 and the second cutting edge 52 of the movable cutting blade 50 will do a cutting action of reciprocally linear movement rather than scissor-like movement for enabling the user to cut the branches effectively and effortlessly without slip of the branch from the cutting mouth 54. Furthermore, the movement stroke of the movable cutting blade 50 is decided by the length of the first sliding groove 34 of the stationary cutting blade 30 and the second sliding groove 56 of the movable cutting blade 50 such that the cutting mouth 54 formed between the first cutting edge 32 of the stationary cutting blade 30 and the second cutting edge 52 of the movable cutting blade 50 can be designed to have sufficient space to receive the branches in different size.

In addition, the movable cutting blade 50 is driven to move relative to the stationary cutting blade 30 by means of the engagement of the teeth portion 74 of the driving bar 70 and the chain 60 such that the gardening shear 10 is easy to make for reducing manufacturing cost. Besides, the user can exchange for a new chain if the chain 60 is broke, thereby reducing maintenance cost. Further, the chain 60 provides flexibility that will not interfere with the teeth portion 74 of the driving bar 70 so that the chain 60 and the teeth portion 74 of the driving bar 70 can be engaged with each other smoothly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A gardening shear comprising:
two handles;
a stationary cutting blade mounted on one of the handles and having a first sliding groove and a first retaining block;
a movable cutting blade having a second sliding groove for insertion of the first retaining block of the stationary cutting blade and a second retaining block inserted into the first sliding groove of the stationary cutting blade such that the movable cutting blade is movable relative to the stationary cutting blade along longitudinal axes of the first sliding groove and the second sliding groove;
a chain having two ends respectively fixed to the movable cutting blade; and
a driving bar having a bottom mounted on the other one of the handles and a top pivotally mounted on the stationary cutting blade and provided with a teeth portion engaged with the chain for driving the movable cutting blade to move relative to the stationary cutting blade.

2. The gardening shear as claimed in claim 1, further comprising an anvil block coupled to a first cutting edge of the stationary cutting blade and having a guiding slot for insertion of a second cutting edge of the movable cutting blade such that the second cutting edge of the movable cutting blade is movable relative to the first cutting edge of the stationary cutting blade along the guiding slot of the anvil block.

3. The gardening shear as claimed in claim 1, wherein the chain includes a reinforcement member fastened to the movable cutting blade.
